(19) United States
(12) Patent Application Publication
(10) Pub. No.: US 2025/0315401 A1
(43) Pub. Date: Oct. 9, 2025

(54) METHOD TO PROVIDE RELIABLE CAN BUS DATA

(71) Applicant: Procon Analytics, LLC, Irvine, CA (US)

(72) Inventors: Jeff Oleksy, San Marcos, CA (US); Alex Campbell, San Diego, CA (US); Dave O'Connor, San Diego, CA (US)

(21) Appl. No.: 19/052,445

(22) Filed: Feb. 13, 2025

Related U.S. Application Data
(60) Provisional application No. 63/631,120, filed on Apr. 8, 2024.

(51) Int. Cl. G06F 13/42

(52) U.S. Cl. CPC G06F 13/4282; G06F 2213/40

(57) ABSTRACT

A controller area network (CAN) controller of an add-on CAN-enabled device is connected to the on-board diagnostics (OBDII) connector of a vehicle. The controller operates initially in a minimal low-power listen-only mode to detect data traffic on a CAN bus of the vehicle. The low-power listen-only mode causes minimal drain on the battery of a 12-volt electrical system of the vehicle. The CAN controller of the add-on device also receives information from an accelerometer, a GPS device, or both, to detect movement of the vehicle. When the CAN controller detects the concurrent presence of data traffic and vehicle movement, the CAN controller switches from the low-power listen-only mode to a fully functional operational mode such that the CAN controller is able to perform all the available features of the CAN controller.

### CROSS-REFERENCES TO RELATED APPLICATIONS

This application claims benefit of U.S. Provisional Patent Application No. 63/631,120, filed Apr. 8, 2024, and which is hereby incorporated by reference.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

A controller area network (CAN) bus is a vehicle standard that enables microcontrollers and other devices to communicate with each other using a message-based protocol. The CAN bus was designed originally to enable signals between devices to be multiplexed onto electrical signal wires to reduce the quantity of copper wiring used in automobiles and other vehicles. Data is transmitted serially between devices in frames. The frames sent by one device are received by all the devices on the bus including the sending device. The CAN bus is implemented as a multi-master bus such that more than one device can be a sending device. Contentions between more than one master trying to send data at the same time are resolved by a priority system.

The CAN bus is used as part of the on-board diagnostics (OBDII) vehicle diagnostics protocol that has been mandatory for automobiles and light trucks produced in the United States since 1996. Accordingly, the CAN bus is accessible via the OBDII connector on the vehicles.

CAN-enabled add-on devices are available in the automotive aftermarket. Such add-on devices include a CAN controller that enables the device to access the CAN bus via the OBDII connector. Accessing the CAN bus enables the add-on device to obtain vehicle data that can be used to evaluate the condition and the performance of the vehicle on a real-time basis. Such add-on devices can also provide features on older model vehicles that were not available or that were costly when the vehicles were initially manufactured. CAN-enabled add-on devices require power to operate; and the power is obtained from the 12-volt electrical system via the OBDII connector. The 12-volt electrical system includes a 12-volt battery and an alternator. During vehicle operation, the battery is charged by the alternator; however, when the vehicle is not running, the add-on device slowly drains the battery if the add-on device remains on in a fully functional mode. If the vehicle remains off for an extended time, the battery could be drained to a level that the battery does not have sufficient energy to start the engine.

As presently implemented, the OBDII connector does not have a signal that indicates whether the vehicle engine is running such that the alternator is charging the battery. Thus, methods for detecting that the engine is running have been proposed. For example, one prior method connected a sense wire to the ignition system to determine when the engine is on. This method is problematic because the ignition wiring differs on a vehicle-by-vehicle basis; and the installer of an add-on CAN-enabled device must determine manually which wire is the ignition wire. Also, physically adding a connection to the ignition wire may affect the vehicle warranty.

Another proposed method is to monitor the voltage on the 12-volt system to determine the state of the engine. Theoretically, when the motor is running, the vehicle alternator is generating a voltage higher than the nominal 12-volt battery voltage to charge the battery. The higher voltage can be connected to indicate that the engine is running. This method is referred to as virtual ignition detection. For many modern vehicles, the virtual ignition detection method is not a reliable indication of when the engine is running such that it is safe to enable the add-on device to read data from the CAN bus. The unreliability of the virtual ignition detection method is caused by several recent innovations in the automobile industry. For example, many conventional automobiles having only internal combustion engines include engine start/stop functionality to improve fuel economy. Such automobiles turn off the engines temporarily when stopped (e.g., at stop lights and when traffic is not moving). Turning of the engine in such situations interferes with virtual ignition detection because the alternator is no longer providing the higher voltage discussed above.

Another recent innovation that precludes virtual ignition detection is the increasing number of hybrid-electric vehicles (HEVs) and plug-in hybrid-electric vehicles PHEVs). HEVs and PHEVs have a similar problem to the engine start/stop functionality described above. In particular, the internal combustion engine can be in the off state while the vehicle is in the on state. Furthermore, the HEVs and PHEVs can be propelled by battery power alone for extended distances meaning that these vehicles can also be moving while the engine is off and the alternator is not charging the 12-volt battery. Because the engine is off, the virtual ignition detection method incorrectly indicates that is not safe to read the CAN bus because the detected state of the battery voltage does not match the “running” state of the vehicle.

Another recent innovation that precludes virtual ignition detection is the development of smart alternators. An alternator supplies DC energy to the vehicle electrical system to energize the spark plugs, to power lights and air circulation, to power entertainment systems and other accessories, and to charge the battery. A conventional alternator provides the maximum power for a given engine RPM regardless of the electrical load on the system. Unlike a conventional alternator, a smart alternator varies the output with respect to the electrical load on the system. When the load on the electrical system is lower (e.g., the headlights are off), the output voltage of the alternator will also be lower. The variation in the output voltage from the alternator causes virtual ignition detection to be unreliable because the electrical system voltage can be below the threshold for ignition detection voltage even when the engine is on.

Electric vehicles present similar problems because the vehicles do not include alternators. Rather, the 12-volt electrical system used to headlights and other non-propulsion related electrical devices is managed by the traction battery management system (BMS), which charges a 12-volt battery as needed. Similar to the issue with electrical systems having smart alternators, the battery is not charged continuously. Thus, detecting higher charging voltages cannot be used reliably as a virtual ignition detector for electric vehicles.

A need exists for a system and method for detecting that the electrical system of a vehicle is on such that the charging system of the vehicle is operable to maintain the charge on a battery so that an add-on CAN-enabled device connected to the CAN bus of the vehicle can operate without risking depleting the charge on the 12-battery of the vehicle.

### SUMMARY

A system and method disclosed herein detect the operational status of a vehicle without relying on detecting the voltage of the 12-volt electrical system. The system and method enable an add-on CAN-enabled device to determine when the vehicle is operational such that the add-on device can access the CAN bus of the vehicle without depleting the energy in the vehicle storage battery.

In an embodiment disclosed herein, a controller area network (CAN) controller of an add-on CAN-enabled device connected to the on-board diagnostics (OBDII) connector of a vehicle operates initially in a minimal low-power listen-only mode to detect data traffic on a CAN bus of the vehicle. The low-power listen-only mode causes minimal drain on the battery of a 12-volt electrical system of the vehicle. The CAN controller of the add-on device also receives information from an accelerometer, a GPS device, or both, to detect movement of the vehicle. When the CAN controller detects the concurrent presence of data traffic and vehicle movement, the CAN controller switches from the low-power listen-only mode to a fully functional operational mode such that the CAN controller is able to perform all the available features of the CAN controller.

One aspect of the embodiments disclosed herein is a method for transitioning an add-on controller area network enabled device (CAN-enabled device) from a low-power listen-only mode to a fully functional mode. The method comprises connecting a CAN-enabled device to a CAN bus on a vehicle. The method initializes the CAN-enabled device to a low-power listen-only mode. The method monitors the CAN bus while in the low-power listen-only mode to detect whether communications traffic is present on the CAN bus. If no communications traffic is detected on the CAN bus, the method maintains the CAN-enabled device in the low-power listen-only mode and continues to monitor the CAN bus. If communications traffic is detected on the CAN bus, the method inputs a signal representing a condition of the vehicle to determine whether the condition is active. If the condition is not active when communications traffic is detected on the CAN bus, the method returns to monitoring the CAN bus in the low-power listen-only mode. If the condition is active when communications traffic is detected on the CAN bus, the method transitions the CAN-enabled device from the low-power listen-only mode to a fully functional mode to enable the CAN-enabled device to transmit and receive communications on the CAN bus. The method reinitializes the CAN-enabled device to a low-power listen-only mode when the CAN-enabled device is no longer transmitting and receiving communications on the CAN bus. The method then returns to monitoring the CAN bus while in the low-power listen-only mode to detect whether communications traffic is present on the CAN bus.

In certain embodiments in accordance with this aspect, the method returns directly to the monitoring the CAN bus after reinitializing the CAN-enabled device to a low-power listen-only mode.

In certain embodiments in accordance with this aspect, the method delays for a selected duration before returning to the monitoring the CAN bus after reinitializing the CAN-enabled device to a low-power listen-only mode.

In certain embodiments in accordance with this aspect, the condition of the vehicle is a motion of the vehicle.

In certain embodiments in accordance with this aspect, the motion of the vehicle is detected by a global positioning system (GPS) device or other navigation device coupled to the CAN-enabled device.

In certain embodiments in accordance with this aspect, the motion of the vehicle is detected by an accelerometer or other motion sensor coupled to the CAN-enabled device.

In certain embodiments in accordance with this aspect, the condition is the presence of a voltage from an accessory port.

In certain embodiments in accordance with this aspect, the condition is the receipt of a signal from a Bluetooth® or other wireless communication system in the vehicle.

Another aspect of the embodiments disclosed herein is a method for transitioning an add-on controller area network enabled device (CAN-enabled device) from a low-power listen-only mode to a fully functional mode. The method comprises connecting a CAN-enabled device to a CAN bus on a vehicle. The method initializes the CAN-enabled device to a low-power listen-only mode. The method monitors a first condition of the vehicle while in the low-power listen-only mode to determine whether the first condition is active. If the first condition is inactive, the method maintains the CAN-enabled device in the low-power listen-only mode and continues to monitor the first condition. If the first condition is active, the method monitors a second condition of the vehicle to determine whether the second condition is active. If the second condition is not active, the method returns to monitoring the first condition in the low-power listen-only mode. If the second condition is active, the method transitions the CAN-enabled device from the low-power listen-only mode to a fully functional mode to enable the CAN-enabled device to transmit and receive communications on the CAN bus. The method reinitializes the CAN-enabled device to a low-power listen-only mode when the CAN-enabled device is no longer transmitting and receiving communications on the CAN bus. The method returns to monitoring the CAN bus while in the low-power listen-only mode to detect whether communications traffic is present on the CAN bus.

Another aspect of the embodiments disclosed herein is an add-on controller area network enabled device (CAN-enabled device) having a low-power listen-only mode and a fully functional mode. The add-on CAN-enabled device comprises a connector configured to engage an onboard diagnostic (OBDII) connector of a vehicle to electrically connect the add-on CAN-enabled device to a CAN bus of the vehicle. The add-on CAN-enabled device further comprises circuitry and programming code within the add-on CAN-enabled device. The circuitry and programming code are configured to initialize the CAN-enabled device to a low-power listen-only mode. The circuitry and programming code are further configured to monitor the CAN bus while in the low-power listen-only mode to detect whether communications traffic is present on the CAN bus. The circuitry and programming code are further configured to remain in the low-power listen-only mode and continue to monitor the CAN bus if no communications traffic is detected on the CAN bus. The circuitry and programming code are further configured to input a signal representing a condition of the vehicle to determine whether the condition is active if communications traffic is detected on the CAN bus. The circuitry and programming code are further configured to return to monitoring the CAN bus in the low-power listen-only mode if the condition is not active when communications traffic is detected on the CAN bus. The circuitry and programming code are further configured to transition the CAN-enabled device from the low-power listen-only mode to a fully functional mode to enable the CAN-enabled device to transmit and receive communications on the CAN bus if the condition is active when communications traffic is detected on the CAN bus. The circuitry and programming code are further configured to reinitialize the CAN-enabled device to a low-power listen-only mode when the CAN-enabled device is no longer transmitting and receiving communications on the CAN bus. The circuitry and programming code are further configured to resume monitoring the CAN bus while in the low-power listen-only mode to detect whether communications traffic is present on the CAN bus.

### BRIEF DESCRIPTIONS OF THE DRAWINGS

FIG. 1 illustrates a simplified block diagram of a CAN bus system in a vehicle showing multiple conventional devices connected to the CAN bus and further showing an add-on CAN-enabled device connected to the CAN bus via an OBDII connector, wherein the add-on CAN-enabled monitors communications traffic on the CAN bus as a first monitored condition and monitors motion as a second monitored condition.

FIG. 2 illustrates a flowchart of the energy-saving operation of the add-on CAN-enabled device of FIG. 1.

FIG. 3 illustrates a block diagram similar to the block diagram of FIG. 1 wherein the add-on CAN-enabled device receives a voltage signal from an accessory port of the vehicle as a second monitored condition.

FIG. 4 illustrates a block diagram similar to the block diagram of FIG. 1 wherein the add-on CAN-enabled device receives a Bluetooth® signal from a Bluetooth® system in the vehicle as a second monitored condition.

FIG. 5 illustrates a flowchart of the energy-saving operation of the add-on CAN-enabled device of FIG. 1 wherein the first monitored condition is communications traffic on the CAN bus and the second monitored condition is at least one of the voltage signal of FIG. 3 and the Bluetooth® signal of FIG. 4.

FIG. 6 illustrates a flowchart of the energy-saving operation of the add-on CAN-enabled device of FIG. 1 wherein the first monitored condition is a first input signal and the second monitored condition is a second input signal.

### DETAILED DESCRIPTION

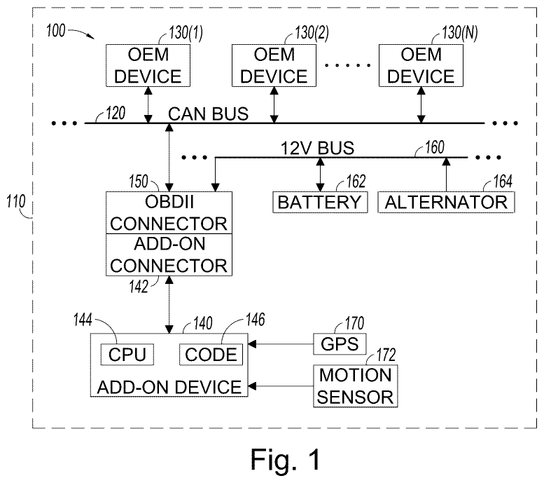

Referring generally to FIGS. 1-6, various exemplary embodiments of an invention may now be described in detail. Where the various figures may describe embodiments sharing various common elements and features with other embodiments, similar elements and features are given the same reference numerals and redundant description thereof may be omitted below.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may. As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

The method disclosed herein enables an add-on CAN-enabled device to operate in a power saving mode to limit the current drain on vehicle system battery.

FIG. 1 illustrates a simplified block diagram of a CAN bus system 100 in a vehicle 110 (shown as a dashed rectangle). The CAN bus system includes a conventional CAN bus 120. Multiple conventional CAN-enabled devices 130(1), 130(2) . . . 130(n) are connected to a CAN bus. The conventional CAN-enabled devices are included when the vehicle is originally manufactured and are shown connected directly to the CAN bus.

FIG. 1 further illustrates an add-on CAN-enabled device 140, which includes a connector 142. The add-on CAN-enabled device includes a processor (CPU) 144 and other internal circuitry along with input/output terminals. The add-on CAN-enabled device includes programming (CODE) 146 executed by the processor to perform the functions described below.

Typically, the add-on CAN-enabled device 140 is not included in the original vehicle 110 and is not physically connected to the CAN-bus 120. For example, the add-on CAN-enabled device may be added by a dealer, a purchaser or other entity after the vehicle is manufactured. The add-on CAN-enabled device may be added to provide one or more features to the vehicle that were not included as part of one of the conventional devices or to provide improved features developed after the vehicle was originally manufactured. Generally, a vehicle owner does not want to modify the CAN-bus 120 physically to provide access for an add-on CAN-enabled device because such modifications could void the vehicle warranty. Instead, the add-on CAN-enabled device includes the connector 142, which is compatible with an onboard diagnostic (OBDII) connector 150. The OBDII connector is electrically connected to the CAN bus and is included with the vehicle when the vehicle is manufactured. The OBDII connector provides electrical access to the signals on the CAN bus for diagnostic equipment and for add-on CAN-enabled device. The OBDII connector also provides power to the add-on CAN-enabled device connected to the connector. The power is provided by a 12-volt electrical system 160 of the vehicle, which is commonly provided power from a battery 162. When the vehicle is operating, the battery is charged by an alternator 164. The power is provided on a specific pin of the OBDII connector and is available to the add-on CAN-enabled device even when the vehicle is not running.

Providing power to the add-on CAN-enabled device 140 is not an issue when the vehicle 110 is operating and the power required to operate the add-on CAN-enabled device is provided by the battery 162 or directly from the alternator 164. Accordingly, the add-on CAN-enabled device has little, if any, effect on the energy stored in the battery while the vehicle is operating.

When vehicle 110 is not operating and the battery 162 is not being charged by the alternator 164, the power required by the add-on CAN-enabled device 140 would be an issue but for the improvement disclosed herein. For example, a fully operational add-on CAN-enabled device may require around 250 milliamperes (mA) of current to power an internal processor and other circuitry including the transmitters to communicate data to the CAN bus 120. Although 250 mA appears to be a relatively small current, the fully operational add-on CAN-enabled device could drain a 100 amp-hour (Ah) storage battery in approximately 400 hours (e.g., approximately 16-17 days). To avoid draining the battery, the add-on CAN-enabled device includes a low-power “listen-only” mode. In the low-power listen-only mode, the add-on CAN-enabled device requires approximately 20 microamperes (20 μA) of current. Accordingly, in the listen-only mode, the add-on CAN-enabled device would not drain the 100 Ah storage battery during the anticipated operational lifetime of the battery or the anticipated operational lifetime vehicle in which the battery is installed.

Although the listen-only mode would solve the battery drainage issue, the add-on CAN-enabled device 140 has very little functionality during the listen-only mode because the CAN bus transmitter within the add-on CAN-enabled device is turned off and the internal processor is not executing programs. The CAN bus receiver with the add-on CAN-enabled device is a low-power device. Accordingly, the CAN bus receiver can remain operational while the add-on CAN-enabled device is in the low-power listen-only mode; and the CAN bus receiver is able to detect communications traffic on the CAN bus 120 from the other CAN-enabled devices 130(1), 130(2) . . . 130(n) on the CAN bus. The add-on CAN-enabled device could use the detected presence of communications traffic to wake up and enter a fully functional mode of operation. However, the traffic on the CAN bus may occur even when the vehicle is not running. For example, the vehicle alarm system is usually always active. Other sensors, such as tire inflation sensors, may activate periodically. Thus, the detection of communications traffic on the CAN bus is not a reliable indication that the vehicle is running.

Rather than rely only on the detection of communications traffic on the CAN bus 120 to wake up and transition to a fully operational mode, the add-on CAN-enabled device 140 of FIG. 1 responds to the detection of communications traffic to perform limited operations to determine whether to restore full functionality. In the illustrated embodiment, the add-on CAN-enabled device accesses one or both of a global positioning system (GPS) device 170 or a motion sensor (e.g., an accelerometer) 172. In the embodiment of FIG. 1, the GPS device and the motion sensor are illustrated as being part of the add-on CAN-enabled device. In alternative embodiments, the add-on CAN-enabled device transmits commands on the CAN bus to request data from a GPS device, a motion sensor, or both that may be incorporated into one or more of the conventional CAN-enable devices 130(1), 130(2) . . . 130(n). If the information from the accessed GPS device or the motion sensor or both indicates that movement is occurring, the add-on CAN-enabled device enters a fully active mode and reads data from other devices on the CAN bus. After reading the data from the other CAN-enabled devices, the add-on CAN-enabled device processes the data. The add-on CAN-enabled device may transmit and receive further data in accordance with internal programming. Thereafter, the add-on CAN-enabled device returns to the listen-only mode and resumes listening for communications traffic on the CAN bus. In certain embodiments, the programming within the add-on CAN-enabled device includes a delay timer, which is activated upon entering the listen-only mode. The add-on CAN-enabled device waits until the delay timer elapses before actively listening for communications traffic so that the add-on CAN-enabled device does not wake up multiple times based on an extended burst of communications traffic on the CAN bus.

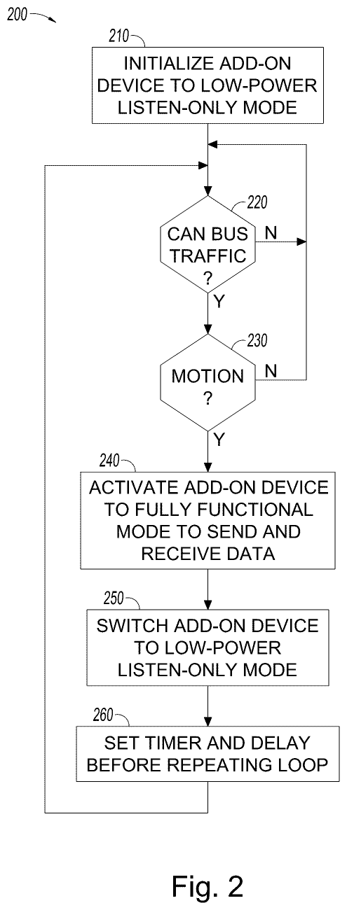

FIG. 2 illustrates a flowchart 200 of the above-described operation of the energy-saving operation of the add-on CAN-enabled device 140 of FIG. 1. In a first activity block 210, the method initializes the add-on CAN-enabled device into the low-power listen-only mode as described above. The method then enters a first decision block 220 wherein the device listens for communications traffic on the CAN bus 120. If no traffic is detected, the method reenters the first decision block. This loop continues until communications traffic is detected.

When communications traffic is detected in the first decision block 220, the method enters a second decision block 230 wherein the method determines whether motion has been detected by either the GPS device 170, the motion sensor 172, or both. If no motion is detected, the method returns to the first decision block. The method continues to loop through both the first decision block and the second decision block until communications traffic and motion are both detected in the same pass through the loop.

Upon detection of communications traffic in the first decision block 220 followed by detection of motion in the second decision block 230, the method enters a second activity block 240 wherein the method transitions the add-on CAN-enabled device 140 to a fully active mode. In the fully active mode, the device may transmit data and receive data on the CAN bus 120 and perform programmed processing functions while the vehicle 110 is operational and is moving.

After completing the processing in the second activity block 240, the method enters a third activity block 250 wherein the method transitions the add-on CAN-enabled device 140 to the low-power listen-only mode. The method may return directly to the first decision block 220; however, in the illustrated embodiment, the method first enters a fourth activity block 260 wherein the method sets an internal periodic timer, which counts down over a selected duration. When the timer countdown is complete the method returns to the first decision block to begin listening for communications traffic. The periodic timer enables the method to delay listening for new communications traffic so that the method does not respond multiple times to an extended burst of communications traffic.

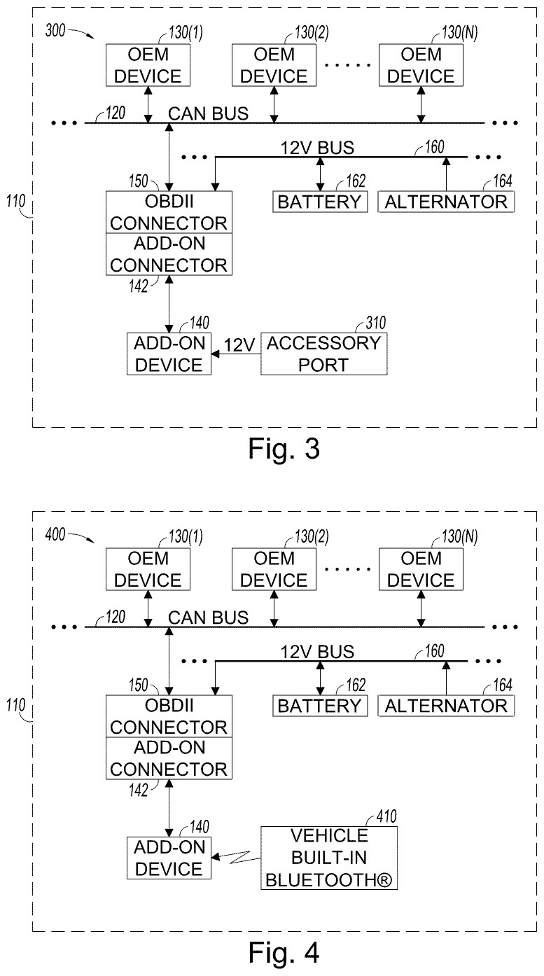

Other combinations of at least two events may be used to determine when the add-on CAN-enabled device 140 wakes up from the low-power listen-only mode. For example, rather than detecting motion in the decision block 230 of FIG. 2, the add-on CAN-enabled device can be connected to an accessory port 310, which is shown in a CAN bus system 300 of FIG. 3. The other elements shown in FIG. 3 correspond to like-numbered elements shown in FIG. 1. The accessory port may be a USB port provided on many modern vehicles or may be a conventional cigarette lighter receptacle. Adding a physical wire to access the 12-volt connection is relatively simple in comparison to adding a wire to the ignition system. In most vehicles, power is provided to the accessory ports only when the ignition switch is on or is in the accessory position. Thus, the presence of power at the accessory port is an alternative indicator of vehicle operation.

Another alternative second event is the detection in of a Bluetooth® signal within a vehicle having a built-in Bluetooth® system 410, which is shown in a CAN bus system 400 of FIG. 4. The built-in Bluetooth® system is powered on when the ignition switch is on or is in the accessory mode. The add-on CAN-enabled device 140 includes an internal or external Bluetooth® transceiver that operates in a low-power listen-only mode. In certain embodiments, the Bluetooth® transceiver is programmed (e.g., paired) to respond only to transmissions from the built-in Bluetooth® system of the vehicle so that the add-on device only wakes up when signals are received from the built-in Bluetooth® system of the vehicle and does not respond to signals from nearby cellular telephones and other devices having Bluetooth® capabilities.

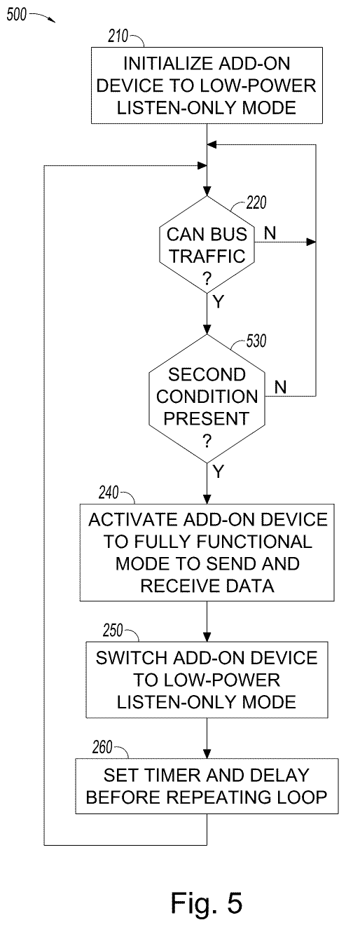

The methods of operation of the embodiments of FIG. 3 and FIG. 4 are illustrated by a flowchart 500 in FIG. 5. The flowchart of FIG. 5 incorporates features of the flowchart of FIG. 2; and corresponding features are numbered as in FIG. 2. In FIG. 5, the second decision block 230 of FIG. 2 is replaced with a second decision block 530. In the second decision block 530 of FIG. 5, the add-on CAN-enabled device 140 determines whether the device is receiving an active second condition (i.e., the second condition is present). In the implementation of the embodiment of FIG. 3, the second condition is the presence of 12 volts from the accessory port. In the implementation of the embodiment of FIG. 4, the second condition is the presence of an active Bluetooth® signal from the built-in vehicle Bluetooth® system. If the monitored second condition is not present, the method returns to the first decision block 220. If the monitored second condition is present, the method proceeds to the second activity block 240 and performs the functions described above with respect to the flowchart 200 of FIG. 2.

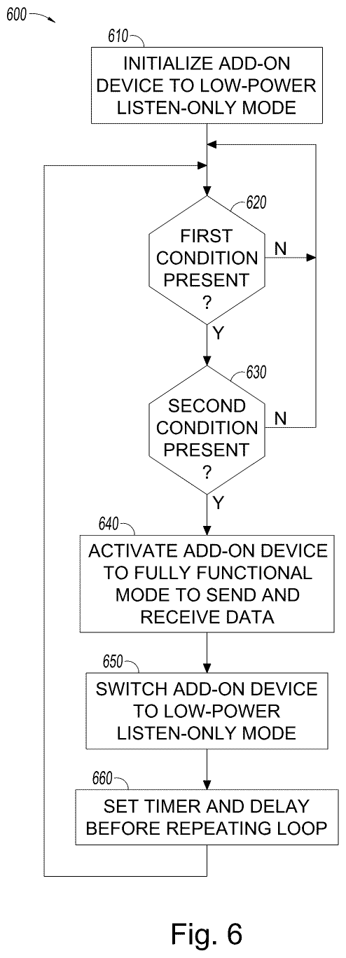

FIG. 6 illustrates a flowchart 600 of an embodiment of the method in which a first condition of the vehicle 110 and a second condition of the vehicle are monitored to determine whether to transition the add-on CAN-enabled device from the low-power listen-only mode to a fully functional mode. In a first activity block 610, the method initializes the add-on CAN-enabled device into the low-power listen-only mode as described above. The method then enters a first decision block 620 wherein the device monitors a first condition of the vehicle. As disclosed above, the first condition can be the presence of communications traffic on the CAN bus 120. The first condition can also be one of the other conditions described above, such as a voltage from the accessory port 310 or a signal from a built-in vehicle Bluetooth® system 410 or the detection of motion. If the first condition is not active when monitored in the first decision block, the method reenters the first decision block. This loop continues until the first condition is active.

When the first condition is active when monitored in the first decision block 620, the method enters a second decision block 630 wherein the method determines whether a second condition is present. In the previously described embodiment, the second condition is motion detected by either the GPS device 170, the motion sensor 172, or both. Other second conditions may also be detected such as the voltage signal from the accessory port or the Bluetooth® signal as described above. If the second condition is not active, the method returns to the first decision block. The method continues to loop through both the first decision block and the second decision block until the first condition and the second condition are both detected as being active in the same pass through the loop.

Upon detection of the active first condition in the first decision block 620 followed by detection of the active second condition in the second decision block 630, the method enters a second activity block 640 wherein the method causes the add-on CAN-enabled device 140 to transition to a fully active mode. In the fully active mode, the device may transmit data and receive data on the CAN bus 120 and perform programmed processing functions while the vehicle 110 is operational and is moving.

After completing the processing in the second activity block 640, the add-on CAN-enabled device 140 enters a third activity block 650 wherein the device transitions to the low-power listen-only mode. The device may return directly to the first decision block 620; however, in the illustrated embodiment, the device first enters a fourth activity block 660 wherein the device sets an internal periodic timer, which counts down over a selected duration. When the timer countdown is complete the device returns to the first decision block to begin listening for communications traffic. The periodic timer enables the device to delay listening for new communications traffic so that the device does not respond multiple times to an extended burst of communications traffic.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A method for transitioning an add-on controller area network enabled device (CAN-enabled device) from a low-power listen-only mode to a fully functional mode, the method comprising:
connecting a CAN-enabled device to a CAN bus on a vehicle;
initializing the CAN-enabled device to a low-power listen-only mode;
monitoring the CAN bus while in the low-power listen-only mode to detect whether communications traffic is present on the CAN bus;
if no communications traffic is detected on the CAN bus, remaining in the low-power listen-only mode and continuing to monitor the CAN bus;
if communications traffic is detected on the CAN bus, inputting a signal representing a condition of the vehicle to determine whether the condition is active;
if the condition is not active when communications traffic is detected on the CAN bus, returning to monitoring the CAN bus in the low-power listen-only mode;
if the condition is active when communications traffic is detected on the CAN bus, transitioning the CAN-enabled device from the low-power listen-only mode to a fully functional mode to enable the CAN-enabled device to transmit and receive communications on the CAN bus;
reinitializing the CAN-enabled device to a low-power listen-only mode when the CAN-enabled device is no longer transmitting and receiving communications on the CAN bus; and
returning to monitoring the CAN bus while in the low-power listen-only mode to detect whether communications traffic is present on the CAN bus.

2. The method as defined in claim 1, wherein the method returns directly to the monitoring the CAN bus after reinitializing the CAN-enabled device to a low-power listen-only mode.

3. The method as defined in claim 1, wherein the method delays for a selected duration before returning to the monitoring the CAN bus after reinitializing the CAN-enabled device to a low-power listen-only mode.

4. The method as defined in claim 1, wherein the condition of the vehicle is a motion of the vehicle.

5. The method as defined in claim 4, wherein the motion of the vehicle is detected by a global positioning system (GPS) device or other navigation device coupled to the CAN-enabled device.

6. The method as defined in claim 4, wherein the motion of the vehicle is detected by an accelerometer or other motion sensor coupled to the CAN-enabled device.

7. The method as defined in claim 1, wherein the condition is the presence of a voltage from an accessory port.

8. The method as defined in claim 1, wherein the condition is the receipt of a signal from a Bluetooth® or other wireless communication system in the vehicle.

9. A method for transitioning an add-on controller area network enabled device (CAN-enabled device) from a low-power listen-only mode to a fully functional mode, the method comprising:
connecting a CAN-enabled device to a CAN bus on a vehicle;
initializing the CAN-enabled device to a low-power listen-only mode;
monitoring a first condition of the vehicle while in the low-power listen-only mode to determine whether the first condition is active;
if the first condition is inactive, remaining in the low-power listen-only mode and continuing to monitor the first condition;
if the first condition is active, monitoring a second condition of the vehicle to determine whether the second condition is active;
if the second condition is not active, returning to monitoring the first condition in the low-power listen-only mode; and
if the second condition is active, transitioning the CAN-enabled device from the low-power listen-only mode to a fully functional mode to enable the CAN-enabled device to transmit and receive communications on the CAN bus;
reinitializing the CAN-enabled device to a low-power listen-only mode when the CAN-enabled device is no longer transmitting and receiving communications on the CAN bus; and
returning to monitoring the CAN bus while in the low-power listen-only mode to detect whether communications traffic is present on the CAN bus.

10. An add-on controller area network enabled device (CAN-enabled device) having a low-power listen-only mode and a fully functional mode, the add-on CAN-enabled device comprising:
a connector configured to engage an onboard diagnostic (OBDII) connector of a vehicle to electrically connect the add-on CAN-enabled device to a CAN bus of the vehicle;
circuitry and programming code within the add-on CAN-enabled device, the circuitry and programming code configured to:
initialize the CAN-enabled device to a low-power listen-only mode;
monitor the CAN bus while in the low-power listen-only mode to detect whether communications traffic is present on the CAN bus;
remain in the low-power listen-only mode and continue to monitor the CAN bus if no communications traffic is detected on the CAN bus;
input a signal representing a condition of the vehicle to determine whether the condition is active if communications traffic is detected on the CAN bus;
return to monitoring the CAN bus in the low-power listen-only mode if the condition is not active when communications traffic is detected on the CAN bus;
transition the CAN-enabled device from the low-power listen-only mode to a fully functional mode to enable the CAN-enabled device to transmit and receive communications on the CAN bus if the condition is active when communications traffic is detected on the CAN bus;
reinitialize the CAN-enabled device to a low-power listen-only mode when the CAN-enabled device is no longer transmitting and receiving communications on the CAN bus; and
resume monitoring the CAN bus while in the low-power listen-only mode to detect whether communications traffic is present on the CAN bus.

11. The device of claim 10, wherein the circuitry and programming code is configured to directly resume monitoring the CAN bus after reinitializing the CAN-enabled device to a low-power listen-only mode.

12. The device of claim 10, wherein the circuitry and programming code is configured to delay for a selected duration before returning to the monitoring the CAN bus after reinitializing the CAN-enabled device to a low-power listen-only mode.

13. The device of claim 10, wherein the condition of the vehicle is a motion of the vehicle.

14. The device of claim 13, wherein the motion of the vehicle is detected by a global positioning system (GPS) device or other navigation device coupled to the CAN-enabled device.

15. The device of claim 13, wherein the motion of the vehicle is detected by an accelerometer or other motion sensor coupled to the CAN-enabled device.

16. The device of claim 10, wherein the condition is the presence of a voltage from an accessory port.

17. The device of claim 10, wherein the condition is the receipt of a signal from a Bluetooth® or other wireless communication system in the vehicle.
